(19) United States
(12) Patent Application Publication
(10) Pub. No.: US 2026/0290117 A1
(43) Pub. Date: Sep. 24, 2026

(54) Device, System, and Method for Triggering Scoring and Settlement By Touching

(71) Applicant: Lingwei ZHOU, Guangdong (CN)

(72) Inventor: Lingwei ZHOU, Guangdong (CN)

(21) Appl. No.: 19/085,136

(22) Filed: Mar. 20, 2025

(51) Int. Cl. G07F 17/32

(52) U.S. Cl. CPC G07F 17/3225; G07F 17/3211; G07F 17/322; G07F 17/3293

(57) ABSTRACT

The present disclosure provides a device, system and method for triggering scoring and settlement by touching, comprising a handheld device and a system built into the handheld device. According to the rules of the game itself and in combination with the usage method of the present disclosure, it can simulate the settlement action of physical chips, achieving fast and accurate scoring and settlement. Moreover, the present disclosure combines wireless communication technology and adopts the touch-to-settle method, which not only retains the sense of ritual and interactivity of physical chips but also realizes fast and accurate scoring and settlement, reduces labor costs, and improves user experience and data security. The present disclosure has broad application prospects and significant competitive advantages in the field of entertainment scoring.

### TECHNICAL FIELD

The present disclosure relates to the technical field of card game supporting equipment, particularly to a device, system, and method for triggering scoring and settlement by touching.

### BACKGROUND

Current entertainment scoring methods mainly include paper-and-pen recording, physical chip counting, and smartphone app digital methods, each of which has issues such as complex operations, low efficiency, error-proneness, and high labor costs. Although smartphone apps have improved efficiency, they lack the ceremonial and interactive aspects of physical chips. This disclosure aims to combine Near Field Communication (NFC) technology and wireless communication technology to simulate the action of physical chip settlement, achieving fast and accurate scoring and settlement. At the same time, addressing the limitation of NFC technology requiring devices to be in close proximity, this disclosure further proposes an innovative solution to combine other wireless communication technologies, enabling more flexible and convenient data interaction between devices.

### SUMMARY

The present disclosure provides a device for triggering scoring and settlement by touching. The device includes a handheld device and a system built into the handheld device, wherein the handheld device comprises a housing provided with several operation buttons, the housing is provided with a display screen, and the housing is internally provided with a chip and a speaker; and the handheld device is capable of aggregating and calculating data, as well as inputting, reading, calculating, transferring, and feeding back electronic chips; and after the settlement is completed, operation feedbacks including but not limited to screen display, indicator lights and sound are given; the inputting, calculating, and feeding back electronic chips can be achieved through at least one handheld device; and the reading and transferring of electronic chips can be achieved by bringing at least two handheld devices close to or touching each other.

The present disclosure further provides a system for triggering scoring and settlement by touching, which includes a card module, a sand table module, and a handheld device module. The card module includes a card body and a chip embedded within the card. The sand table module includes a sand table body, a data processing module embedded within the sand table, and a power module. The handheld device module includes a handheld device body, and the handheld device chip includes an information input module, a data verification module, a data settlement module, an NFC module, a wireless communication module, a power module, an information output module, and an MCU module.

The present disclosure further provides a method for triggering scoring and settlement by touching, which includes the following steps:
Step 1: preparing before entering a game, players inputting identical multi-digit characters in handheld devices to join a same game scoring organization;
Step 2: selecting a role of the device (a player handheld device or a pot device);
Step 3: a first player to enter the handheld device obtaining a game initialization setup permission and entering a game scoring rule initialization setting page;
Step 4: waiting for other players'devices to join (displaying a joining process page).
Step 5: a player score display page.
Step 6: losers placing bets, winners gaining credits, and viewing rankings.

The present disclosure aims to combine Near Field Communication (NFC) technology and wireless communication technology to simulate physical chip settlement actions, achieving fast and accurate score settlement. At the same time, addressing the limitation of NFC technology requiring devices to be in close proximity, the present disclosure further proposes an innovative solution to integrate other wireless communication technologies, enabling more flexible and convenient data interaction between devices.

The device, according to the rules of the game itself and in conjunction with the system and usage method involved in the present disclosure, can simulate physical chip settlement actions, achieving fast and accurate score settlement. Moreover, the present disclosure incorporates wireless communication technology, adopting a “touch-to-settle” method, greatly enhancing the flexibility, playability, and convenience of chip settlement.

### BRIEF DESCRIPTION OF DRAWINGS

The drawings, which form a part of the specification, are provided to further explain the present disclosure. The illustrative embodiments and the descriptions thereof are intended to explain the disclosure and do not constitute an improper limitation of the disclosure. In the drawings:

FIG. 1 shows a schematic diagram of the usage logic of a device for triggering scoring and settlement by touching according to the present disclosure;

FIG. 2 shows a system flowchart of a system for triggering scoring and settlement by touching according to the present disclosure;

FIG. 3 shows a schematic diagram of the interactive operation of two devices in a system for triggering scoring and settlement by touching according to the present disclosure;

FIG. 4 shows a logic diagram of the interactive information transmission during the touch operation of two devices in a system for triggering scoring and settlement by touching according to the present disclosure;

FIG. 5 illustrates the logic diagram of information transmission in the multi-device interaction of a system for triggering scoring and settlement by touching according to the present disclosure.

FIG. 6 illustrates the logic diagram of the actual verification operations of each module in the multi-device interaction of a system for triggering scoring and settlement by touching according to the present disclosure.

### DESCRIPTION OF EMBODIMENTS

The technical solution in the embodiment of the present disclosure will be clearly and completely described below with reference to the drawings. Obviously, the described embodiment is part of, rather than all of the embodiments of the present disclosure. The following description of at least one exemplary embodiment is illustrative in nature and is in no way intended to limit the present disclosure, its application or uses. Based on the embodiments in the present disclosure, all other embodiments obtained by those skilled in the art without creative work belong to the scope of protection of the present disclosure.

It should be noted that the terminology used here is only for describing specific embodiments, and is not intended to limit exemplary embodiments according to the present application. As used herein, the singular form is also intended to include the plural form unless the context clearly indicates otherwise. Furthermore, it should be appreciated that when the terms “comprising” and/or “including” are used in this specification, they specify the presence of features, steps, operations, devices, components and/or combinations thereof.

Unless otherwise specified, the relative arrangement of components and steps, numerical expressions and numerical values set forth in these embodiments do not limit the scope of the present disclosure. At the same time, it should be appreciated that for the convenience of description, the dimensions of various parts shown in the drawings are not drawn according to the actual scale relationship. Techniques, methods and equipment known to those skilled in the art may not be discussed in detail, but in appropriate cases, they should be regarded as part of the authorization specification. In all the examples shown and discussed herein, any specific values should be interpreted as illustrative, and not as limiting. Therefore, other examples of exemplary embodiments may have different values. It should be noted that similar numbers and letters indicate similar items in the following drawings, therefore once an item is defined in one drawing, it does not need to be further discussed in subsequent drawings.

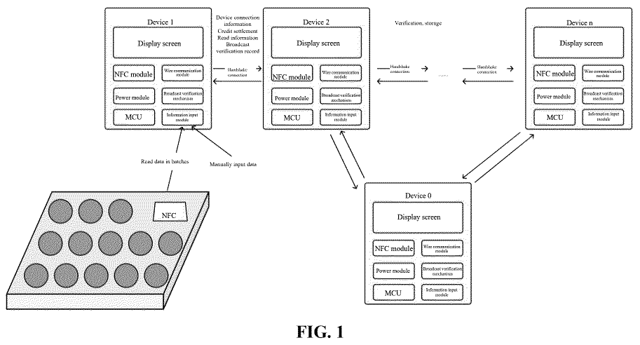

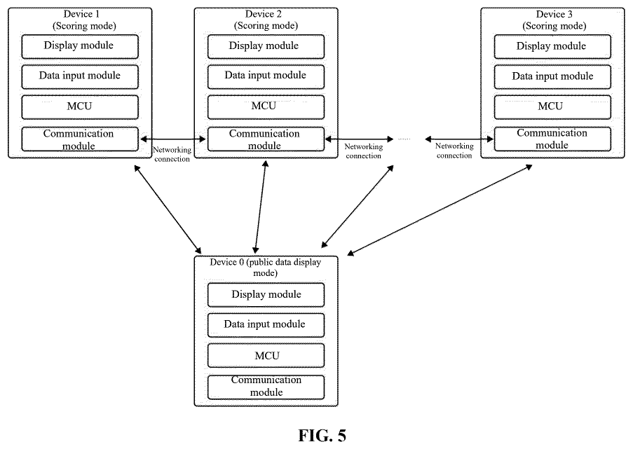

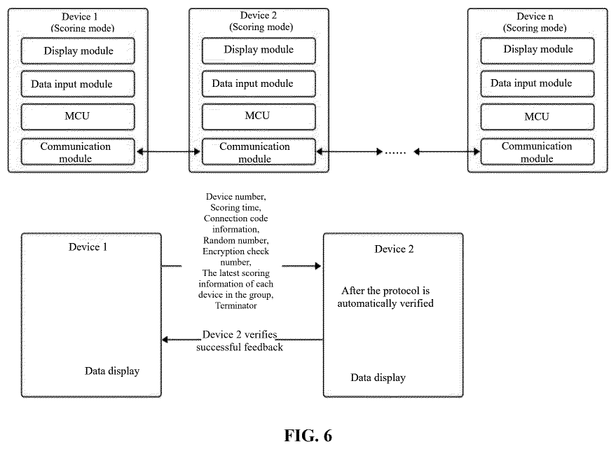

As shown in FIG. 1-6, the present disclosure provides a device, system, and method for triggering scoring and settlement by touching, including a device for triggering scoring and settlement by touching, a system for triggering scoring and settlement by touching, and a method for triggering scoring and settlement by touching.

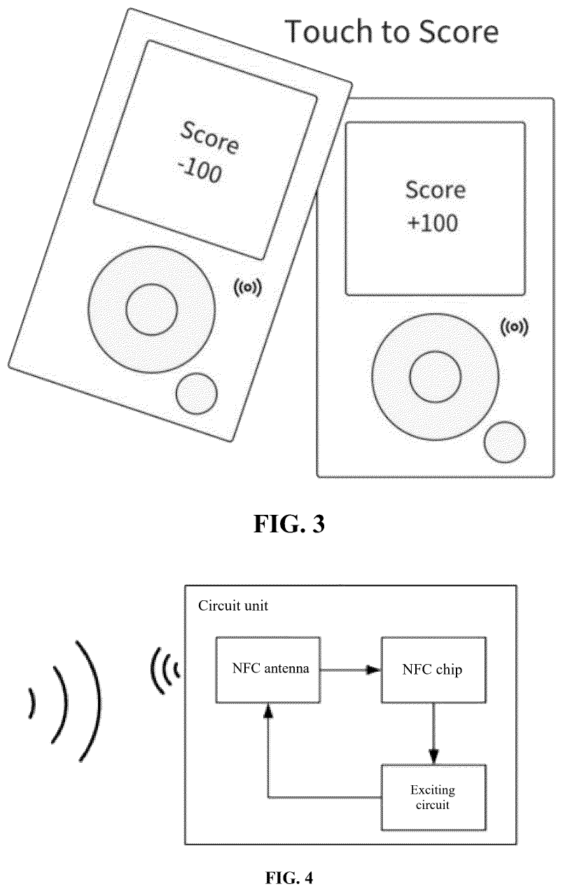

The device for triggering scoring and settlement by touching involved in the present disclosure, see FIG. 1 and FIG. 3, includes a handheld device, special cards and a sand table. The handheld device includes a housing, on which several operation buttons are provided, and a display screen is provided on the housing. A chip and a speaker are provided inside the housing. The handheld device can summarize and calculate data. The handheld device can input, read, calculate, transfer and feedback electronic chips, and give operation feedback including but not limited to screen display, indicator lights, sounds, etc. after the settlement is completed. The input, calculation and feedback of electronic chips can be realized through at least one handheld device, and the reading and transfer of electronic chips can be realized by bringing at least two handheld devices close to or touching each other.

Optionally, in addition to button and touch input methods, the digital input for scoring can also be achieved by holding down a button or the screen for a certain period of time, combined with a voice input module, to input the required information via voice.

The special card is equipped with a chip, and the sand table is equipped with at least one identification slot for recognizing the card. The sand table can read the card data in batches, and the handheld device can read the sand table data. The handheld device can summarize and calculate the sand table data, and it is capable of inputting, reading, calculating, transferring, and feeding back electronic chips. The inputting, calculating, and feeding back of the electronic chips can be achieved through at least one handheld device. Reading electronic chips and transferring electronic chips or transmitting batch-read information can be achieved by bringing at least two handheld devices close to or touching each other.

Optionally, the device also includes a control host, which defaults to the handheld device of the first player to join. The control host can act as a hub during data aggregation and settlement.

By setting up the aforementioned device, the present disclosure allows handheld devices to replace electronic chips to achieve multiple transaction nodes during actual use.

Firstly, players can obtain electronic chips before the game without using physical electronic chips, but instead through virtual electronic chips in the handheld device. There are two methods to determine the initial number of electronic chips for each player when the game starts.
Method 1: each participating player can hold the handheld device, input the initial electronic chips through the buttons on the handheld device to confirm the initial number of electronic chips, which is then displayed on the screen and announced through the speaker.
Method 2: after establishing a room through the handheld device held by the first player of the game, the initial number of electronic chips is set for each subsequent player, and is then displayed on the screen and announced through the speaker.

Secondly, when calculating the card-shaped electronic chips for the players during the game, it is achieved through the handheld device in conjunction with the sand table and special cards.

After players obtain cards during the game phase, they place special cards in the recognition slot of the sand table. The sand table can identify different cards by reading the chips in the special cards and centrally organize the information corresponding to the cards. At this point, players can bring their handheld devices close to and touch the sand table to obtain the data of the special cards centrally organized by the sand table. The handheld device then performs calculations and displays the corresponding electronic chips or other information on the screen. In this way, players can obtain the precise score corresponding to the card type without having to observe the card type themselves, perform complex calculations, or verify the results. The accuracy is extremely high, the calculation speed is very fast, and there is almost no calculation error. This method is quite friendly and practical for novice players or more complex card games involving electronic chip calculations.

The electronic chip interaction after the player plays the game is the core technology of this disclosure, and the electronic chip interaction within the handheld device is achieved by touching.

When the game ends and the player needs to settle the electronic chips through the handheld device, there are at least two settlement methods.
Method 1: the handheld devices of both parties transferring credits are brought close or touched to activate the input state for transferring credits on the handheld device; the loser inputs the number of credits to be transferred (via voice or button) on their handheld device and confirms the transfer, completing the credits transfer.
Method 2: the player who needs to transfer credits in the game inputs the number of credits to be transferred (via voice or button) on his handheld device and confirms; the handheld devices of both parties transferring credits are brought close or touched, and the electronic chip interaction is completed.
Method 3: after the device acting as the pot receives multiple rounds of credit transfers from multiple players, the player who wins the pot credits allows his handheld device to approach or touch the device acting as the pot, and his handheld device is activated to enter the state of receiving the pot credits; the player (via voice or button) inputs the number of credits to be transferred and confirms, thereby completing the operation of the player collecting the won credits from the pot.

Finally, after each round of the game ends and the credit interaction is completed through the “touch” method, the handheld device will provide feedback on the interaction results; the feedback can be displayed on the screen or broadcasted via the speaker, thus informing the player; the player can verify if there are any doubts in the electronic chip interaction through the feedback results.

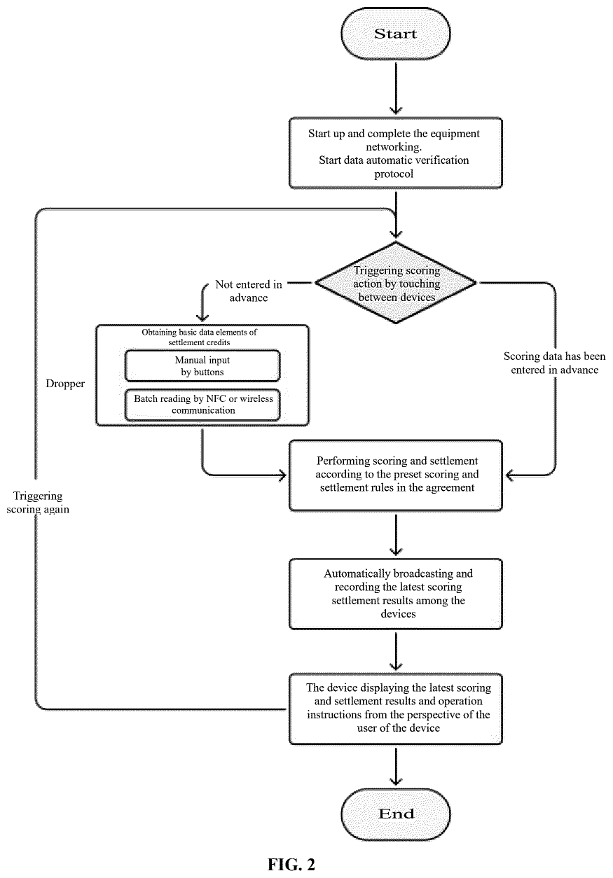

The present disclosure also relates to a system for triggering scoring and settlement by touching. With reference to FIGS. 2-6, the system includes a card module, a sand table module, and a handheld device module. The card module includes a card body and a chip embedded within the card. The sand table module includes a sand table body, a data processing module embedded within the sand table, and a power module. The handheld device module includes a handheld device body, and the handheld device chip includes an information input module, a data verification module, a data settlement module, an NFC module, a wireless communication module, a power module, an information output module, and an MCU module.

In the system, the power supply requirements of each sand table can be first met via the data processing module and power module in the sand table module through the aforementioned modules and in conjunction with physical devices during actual use. The data processing module, in coordination with the chip of the special card module, can read and centrally organize the information carried in single or multiple special cards.

The handheld device chip includes an information input module, a data verification module, a data settlement module, a NFC module, a wireless communication module, a power module, an information output module, and a MCU module.

The power module can provide electrical energy supply for the handheld device.

The information input module can first achieve information input through buttons, and secondly, it can cooperate with the sand table module to realize the data collection function when the handheld device touches the sand table.

The data settlement module can achieve the data calculation and processing functions in the handheld device.

The NFC module can achieve the information interaction and transmission function between the sand table and special cards.

The wireless communication module can achieve the information interaction and transmission function between handheld devices and between handheld devices and the sand table.

The information output module can cooperate with the wireless communication module to achieve the virtual chip interaction function between handheld devices.

The MCU module is mainly used for data storage in handheld devices, and also has auxiliary data calculation and post-interaction verification functions.

Optionally, the information input module includes a manual input module, a voice input module, and an information reception module. The information output module includes an optical display module and an audio feedback module.

With this setup, it is possible to manually input data via buttons and receive data through touch interaction. The optical display module and audio feedback module provide dual feedback, enhancing the user experience.

Optionally, the identification chip inside the card includes a magnetic chip and a data chip. The magnetic chip is used for magnetic fit with the sand table, while the data chip is used for data recognition in conjunction with the sand table.

This setup ensures ease and stability when placing special cards on the sand table, thereby improving the gaming experience.

Optionally, the data processing module includes a data acquisition module and a data transmission module.

With this setup, the data processing module can be split, and the combination of two modules can be configured to reduce the overall cost of the equipment.

It should be noted that the handheld device chip includes a data processing unit, a communication protocol unit, and a data broadcast and comparison processing unit.

With this setup, the dual feedback effect of sound and light can be achieved after the electronic chip settlement is completed.

The present disclosure also relates to a method for triggering scoring and settlement by touching, which, in conjunction with FIGS. 1-6, includes the following steps:
Step 1: preparing before entering a game, players inputting identical multi-digit characters in handheld devices to join a same game scoring organization;
Step 2: selecting a role of the device (a player handheld device or a pot device);
Step 3: a first player to enter the handheld device obtaining a game initialization setup permission and entering a game scoring rule initialization setting page;
Step 4: waiting for other players'devices to join (displaying a joining process page).
Step 5: a player score display page.
Step 6: losers placing bets, winners gaining credits, and viewing rankings.

The Step 1 of the method further comprises:
Step 1.1: allowing the handheld device to approach or touch a control host to obtain gameplay data and calculation data; and
Step 1.2: the players inputting an identical multi-digit number to establish a local game room.

The Step 2 of the method further comprises:
Step 2.1: selecting one of the devices (player OR pot) by inputting commands, wherein input of the commands is achieved through buttons of the handheld device or touching.

The Step 3 of the method further comprises:
Step 3.1: entering the game rule initialization setting page, wherein if game rules are stored in the handheld device, the handheld device must be equipped with a storage module; and
Step 3.2: entering the game rule initialization setting page, wherein if game rules need to be accepted by the handheld device before use, the control host is required to participate.

The Step 4 of the method further comprises:
Step 4.1: setting a join prompt during the joining process, which displays the number of players who have joined and a total number of players on a screen;
Step 4.1 further comprises:
Step 4.1.1: displaying on a first handheld device to enter the room and select the game rules, showing pages of the number of players who have joined and the total number of players after initialization setup is completed; and
Step 4.1.2: displaying on each handheld device of the player entering the room.

The Step 5 of the method further comprises:
Step 5.1: the first player to enter the room setting a total score value for each player by default setting or user-defined setting; and
Step 5.2: the handheld device displaying scores after each game settlement.

The Step 6 of the method further comprises:
Step 6.1: a method for placing bets; triggering voice input or manually adjusting betting credits by touch or buttons, and then bring the handheld device close to or touch the winner's handheld device;
Step 6.2: the winner receiving credits; (credit transfer) both parties involved in the credit transfer allow their handheld devices to touch each other, automatically activating a credit transfer state on both devices, wherein the loser inputs a value of the credits to be transferred, thereby completing a scoring action;
Step 6.3: viewing rankings; wherein each player can conveniently view the latest credits and ranking status of all players through their respective handheld devices, and the devices distinguish the players'data by colors or fonts with highlighting; and
Step 6.4: each player's handheld device announcing the credits via voice broadcast or providing a brief sound effect upon completion of the settlement (indicating success or failure of the settlement).

Through the above steps, in conjunction with physical devices, it is possible to assist in the complete operational process of various existing card games, simulate the action of physical chip settlement, achieve fast and accurate score settlement, and with the integration of wireless communication technology, the “touch-to-settle” method greatly enhances the flexibility, playability, and convenience of chip settlement.

From the above description, it can be seen that the embodiments of the present disclosure achieve the following technical effects: in summary, the device, system, and method for triggering scoring and settlement by touching involved in the present disclosure, when used in practice, first, allow players to obtain electronic chips before the game without using physical electronic chips, but through virtual electronic chips in handheld devices; second, when players calculate the card-shaped electronic chips during the game, it is achieved through the handheld device in conjunction with a sand table and special cards; then, the core technology of the present disclosure is the electronic chip interaction after the game, which is realized by “touching” to achieve electronic chip interaction within the handheld devices; finally, after each round of the game ends and the score interaction is completed through the “touching” method, the handheld device will provide feedback on the interaction results, and the feedback can be displayed on the screen or announced through the speaker, thereby informing the player, who can verify whether there are any doubts about the electronic chip interaction through the feedback results. According to the rules of the game itself, in conjunction with the system and usage method involved in the present disclosure, this device can simulate the action of physical chip settlement, achieving fast and accurate scoring and settlement. Moreover, the present disclosure combines wireless communication technology and NFC technology, and adopts the touch-to-settle method, which greatly enhances the flexibility, playability, and convenience of chip settlement.

In the description of the present disclosure, it should be appreciated that directional terms such as “front, rear, up, down, left, right”, “horizontal, vertical, perpendicular, horizontal” and “top, bottom” etc. indicate the orientation or positional relationship based on the orientation or positional relationship shown in the drawings, and are only for the convenience of describing the present disclosure and simplifying the description. In the absence of a contrary explanation, these directional terms do not indicate or imply that the device or element referred to must have a specific orientation or be constructed and operated in a specific orientation, and therefore should not be understood as limiting the scope of protection of the present disclosure; the directional terms “inside, outside” refer to the inside and outside relative to the contour of each component itself.

For the convenience of description, spatial relative terms such as “on . . . ”, “above . . . ”, “on the upper surface of . . . ”, “upper” etc. may be used here to describe the spatial positional relationship of a device or feature with other devices or features as shown in the drawings. It should be appreciated that spatial relative terms are intended to encompass different orientations of the device in use or operation other than the orientation described in the drawings. For example, if the device in the drawing is inverted, the device described as “above other devices or structures” or “on other devices or structures” will subsequently be positioned as “below other devices or structures” or “under other devices or structures”. Thus, the exemplary term “above” can include both “above” and “below” orientations. The device can also be positioned in other different ways (rotated 90 degrees or in other orientations), and the spatial relative descriptions used here should be interpreted accordingly.

In addition, it should be noted that the use of terms such as “first”, “second” etc. to define components is for the convenience of distinguishing the corresponding components. Unless otherwise stated, the above terms have no special meaning, and therefore should not be understood as limiting the scope of protection of the present disclosure.

The above description is only a preferred embodiment of the present disclosure and is not intended to limit the present disclosure. For those skilled in the art, the present disclosure can have various modifications and changes. Any modifications, equivalent replacements, improvements etc. made within the spirit and principles of the present disclosure should be included within the scope of protection of the present disclosure.

What is claimed is:

1. A device for triggering scoring and settlement by touching, the device comprising a handheld device, wherein
the handheld device comprises a housing provided with several operation buttons, the housing is provided with a display screen, and the housing is internally provided with a chip and a speaker; and
the handheld device is capable of aggregating and calculating data, as well as inputting, reading, calculating, transferring, and feeding back electronic chips; and
after the settlement is completed, operation feedbacks including but not limited to screen display, indicator lights and sound are given;
the inputting, calculating, and feeding back electronic chips can be achieved through at least one handheld device; and
the reading and transferring of electronic chips can be achieved by bringing at least two handheld devices close to or touching each other.

2. The device for triggering scoring and settlement by touching according to claim 1, wherein
the device further comprises a number of special cards and a sand table, the special cards are equipped with chips, and the sand table is provided with at least one identification slot for recognizing the cards, wherein the sand table can read the data of the cards in batches, and the handheld device can read data of the sand table;
the handheld device is capable of aggregating and calculating the data of the sand table, the handheld device is capable of inputting, reading, calculating, transferring, and feeding back electronic chips, and the inputting, calculating, and feeding back of the electronic chips can be achieved through at least one handheld device;
the reading and transferring of the electronic chips or the transmission of batch-read information can be achieved by bringing at least two devices close to or touching each other.

3. The device for triggering scoring and settlement by touching according to claim 1, wherein
the device further comprises a control host, which is by default the handheld device of a first player to join, and the control host can act as a hub during data aggregation and settlement.

4. A system for triggering scoring and settlement by touching, comprising a handheld device module, wherein
the handheld device module comprises a handheld device body and a handheld device chip, and the handheld device chip comprises;
an information input module, a data validation module, a data settlement module, a NFC module, a wireless communication module, a power module, an information output module, and a MCU module.

5. The system for triggering scoring and settlement by touching according to claim 4, wherein the system further comprises a card module and a sand table module, wherein
the card module comprises a card body and a chip disposed inside the card; and
the sand table module comprises a sand table body, a data processing module disposed inside the sand table, and a power module.

6. The system for triggering scoring and settlement by touching according to claim 4, wherein
identification chips inside the card comprise a magnetic chip and a data chip internally disposed within the card, wherein the magnetic chip is configured to achieve magnetic fit with the sand table, and the data chip is configured to cooperate with the sand table for data recognition;
the information input module comprises a manual input module, a voice input module, and an information reception module; and
the information output module comprises an optical display module and an audio feedback module.

7. The system for triggering scoring and settlement by touching according to claim 4, wherein
the data processing module comprises a data collection module and a data transmission module.

8. The system for triggering scoring and settlement by touching according to claim 4, wherein
the handheld device chip comprises a data processing unit, a communication protocol unit, and a data broadcasting and comparison processing unit.

9. A method for triggering scoring and settlement by touching, wherein the method comprises the following steps:
Step 1: preparing before entering a game, players inputting identical multi-digit characters in handheld devices to join a same game scoring organization;
Step 2: selecting a role of the device (a player handheld device or a pot device);
Step 3: a first player to enter the handheld device obtaining a game initialization setup permission and entering a game scoring rule initialization setting page;
Step 4: waiting for other players'devices to join (displaying a joining process page).
Step 5: a player score display page.
Step 6: losers placing bets, winners gaining credits, and viewing rankings.

10. The method for triggering scoring and settlement by touching according to claim 9, wherein Step 1 of the method further comprises:
Step 1.1: allowing the handheld device to approach or touch a control host to obtain gameplay data and calculation data.

11. The method for triggering scoring and settlement by touching according to claim 9, wherein the Step 1 of the method further comprises:
Step 1.2: the players inputting an identical multi-digit number to establish a local game room.

12. The method for triggering scoring and settlement by touching according to claim 9, wherein the Step 2 of the method further comprises:
Step 2.1: selecting one of the devices (player OR pot) by inputting commands, wherein input of the commands is achieved through buttons of the handheld device or touching.

13. The method for triggering scoring and settlement by touching according to claim 9, wherein the Step 3 of the method further comprises:
Step 3.1: entering the game rule initialization setting page, wherein if game rules are stored in the handheld device, the handheld device must be equipped with a storage module.

14. The method for triggering scoring and settlement by touching according to claim 9, wherein the Step 3 of the method further comprises:
Step 3.2: entering the game rule initialization setting page, wherein if game rules need to be accepted by the handheld device before use, the control host is required to participate.

15. The method for triggering scoring and settlement by touching according to claim 9, wherein the Step 4 of the method further comprises:
Step 4.1: setting a join prompt during the joining process, which displays the number of players who have joined and a total number of players on a screen;
Step 4.1 further comprises
Step 4.1.1: displaying on a first handheld device to enter the room and select the game rules, showing pages of the number of players who have joined and the total number of players after initialization setup is completed; and
Step 4.1.2: displaying on each handheld device of the player entering the room.

16. The method for triggering scoring and settlement by touching according to claim 9, wherein the Step 5 of the method further comprises:
Step 5.1: the first player to enter the room setting a total score value for each player by default setting or user-defined setting; and
Step 5.2: the handheld device displaying scores after each game settlement.

17. The method for triggering scoring and settlement by touching according to claim 9, wherein the Step 6 of the method further comprises:
Step 6.1: a method for placing bets; triggering voice input or manually adjusting betting credits by touch or buttons, and then bring the handheld device close to or touch the winner's handheld device.

18. The method for triggering scoring and settlement by touching according to claim 9, wherein the Step 6 of the method further comprises:
Step 6.2: the winner receiving credits; (credit transfer) both parties involved in the credit transfer allow their handheld devices to touch each other, automatically activating a credit transfer state on both devices, wherein the loser inputs a value of the credits to be transferred, thereby completing a scoring action.

19. The method for triggering scoring and settlement by tapping according to claim 9, wherein the Step 6 of the method further comprise:
Step 6.3: viewing rankings; wherein each player can conveniently view the latest credits and ranking status of all players through their respective handheld devices, and the devices distinguish the players'data by colors or fonts with highlighting; and
Step 6.4: each player's handheld device announcing the credits via voice broadcast or providing a brief sound effect upon completion of the settlement (indicating success or failure of the settlement).
